(19) United States
(12) Patent Application Publication
(10) Pub. No.: US 2012/0127487 A1
(43) Pub. Date: May 24, 2012

(54) METHODS AND APPARATUSES FOR MEASURING THE THICKNESS OF GLASS SUBSTRATES

(76) Inventor: Sergey Potapenko, Painted Post, NY (US)

(21) Appl. No.: 12/949,307

(22) Filed: Nov. 18, 2010

(51) Int. Cl. G01B 11/06

(52) U.S. Cl. 356/632

(57) ABSTRACT

Methods and apparatuses for determining a thickness of a glass substrate are disclosed. The method includes conveying the glass substrate past an optical measurement head and determining a measurement separation distance dₘ between a first surface plane of the glass substrate and the optical measurement head. A position of the optical measurement head relative to the first surface plane of the glass substrate is adjusted based on the measurement separation distance dₘ between the first surface plane of the glass substrate and the optical measurement head such that the glass substrate is within a working range of the optical measurement head as the glass substrate is conveyed past the optical measurement head. A thickness Tₘ of the glass substrate is measured with the optical measurement head as the glass substrate is conveyed past the optical measurement head.

### BACKGROUND

1. Field

The present specification generally relates to methods and apparatuses for measuring the thickness of glass substrates and, more specifically, to online methods and apparatuses for measuring the thickness of moving glass substrates.

2. Technical Background

Thin glass substrates are commonly employed in a variety of consumer electronic devices such as smart phones, laptop computers, LCD displays and LCD televisions. As the performance and consumer demand for such devices increases, so to does the need to efficiently mass produce high quality glass substrates utilized in the manufacture of such devices. Such thin glass substrates may be manufactured by a down draw process such as, for example, the fusion draw process. The fusion draw process yields continuous glass ribbons which have surfaces with superior flatness and smoothness when compared to glass ribbons produced by other methods. The continuous glass ribbons may be sectioned into glass substrates for incorporation into consumer electronic devices.

While draw processes may be useful for forming thin glass substrates with the desired surface properties, the thickness of the glass may be difficult to control, particularly in the case of thinner glass substrates. Accordingly, manufacturers of glass substrates are constantly trying to improve their glass manufacturing processes and systems so they can manufacture glass substrates that meet the performance requirements of LCD panel manufacturers, including glass substrates having increased size and decreased thickness. In particular, on-line thickness measurements become increasingly more difficult to perform as the size of the glass substrates increases and the overall thickness of the glass substrates decreases. Both of these factors create a certain amount variance in the position and/or the angular orientation of the glass substrate during manufacture and, as a result, impact the accuracy of on-line thickness measurements. Substrate thickness information is used as feedback control for adjusting the down draw process and, in turn, the thickness and the thickness uniformity of the glass substrates produced by the down draw process. The thickness information may also be utilized for quality control purposes to prevent glass substrates which are not within established specifications from proceeding to downstream manufacturing.

Accordingly, a need exists for alternative methods and apparatuses tolerant to variations of glass position and orientation for online measurement of the thickness of glass substrates during manufacture.

### SUMMARY

According to one embodiment, a method for determining a thickness of a glass substrate having a pair of opposed surface planes bounded by edges includes conveying the glass substrate past an optical measurement head positioned opposite a first surface plane of the glass substrate. A measurement separation distance dₘ between the first surface plane of the glass substrate and the optical measurement head is determined as the glass substrate is conveyed past the optical measurement head. A position of the optical measurement head relative to the first surface plane of the glass substrate is adjusted based on the measurement separation distance dₘ between the first surface plane of the glass substrate and the optical measurement head such that the first surface plane of the glass substrate is within the working range of the optical measurement head as the glass substrate is conveyed past the optical measurement head. The thickness Tₘ of the glass substrate is then measured with the optical measurement head as the glass substrate is conveyed past the optical measurement head.

In another embodiment, an online thickness measurement gauge for measuring a thickness Tₘ of a glass substrate having a first surface plane opposed to a second surface plane and bounded by edges includes an optical measurement head; a positioning device coupled to the optical measurement head; and a control unit communicatively coupled to the optical measurement head and the positioning device. The control unit determines the thickness Tₘ of the glass substrate with the optical measurement head. The control unit also determines a measurement separation distance dₘ between the optical measurement head and the first surface plane of the glass substrate. The control unit adjusts a position of the optical measurement head relative to the first surface plane with the positioning device based on the measurement separation distance dₘ between the first surface plane and the optical measurement head such that the glass substrate is maintained within a working range of the optical measurement head as the glass substrate is conveyed past the optical measurement head.

Additional features and advantages of the invention will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIGS. 1A and 1B schematically depict two embodiments of online thickness measurement gauges according to embodiments described herein;

FIG. 2 schematically depicts the tilt angle tolerance of an optical measurement head;

FIG. 3 graphically depicts the relationship between optical path length and the tilt angle of the optical measurement device for a glass substrate with a thickness of 0.7 mm and a refractive index of 1.52;

FIGS. 4A and 4B schematically depicts one embodiment of an optical measurement device which may be used to compensate for the tilt angle and/or tip angle of a glass substrate during an online thickness measurement;

FIG. 5 graphically depicts an intensity distribution from an angle detector of an optical measurement device for (a) a glass substrate which is substantially parallel with the imaging plane of the optical measurement device and (b) a glass substrate which is tilted (i.e., non-parallel) with respect to the imaging plane of the optical measurement device;

FIG. 6 graphically depicts an intensity distribution from an angle detector of an optical measurement device for (a) a glass substrate which is substantially parallel with the imaging plane of the optical measurement device and (b) a glass substrate which is both tilted and tipped with respect to the imaging plane of the optical measurement device;

FIG. 7 schematically depicts an online thickness measurement gauge with an orientation of the optical measurement head adjusted to compensate for the tilt angle of a glass substrate;

FIG. 8 schematically depicts an online thickness measurement gauge with an orientation of the optical measurement head adjusted to compensate for the tip angle of a glass substrate; and

FIG. 9 schematically illustrates a block diagram of an exemplary glass manufacturing system in which the online thickness measurement method and online thickness measurement gauge may be utilized.

### DETAILED DESCRIPTION

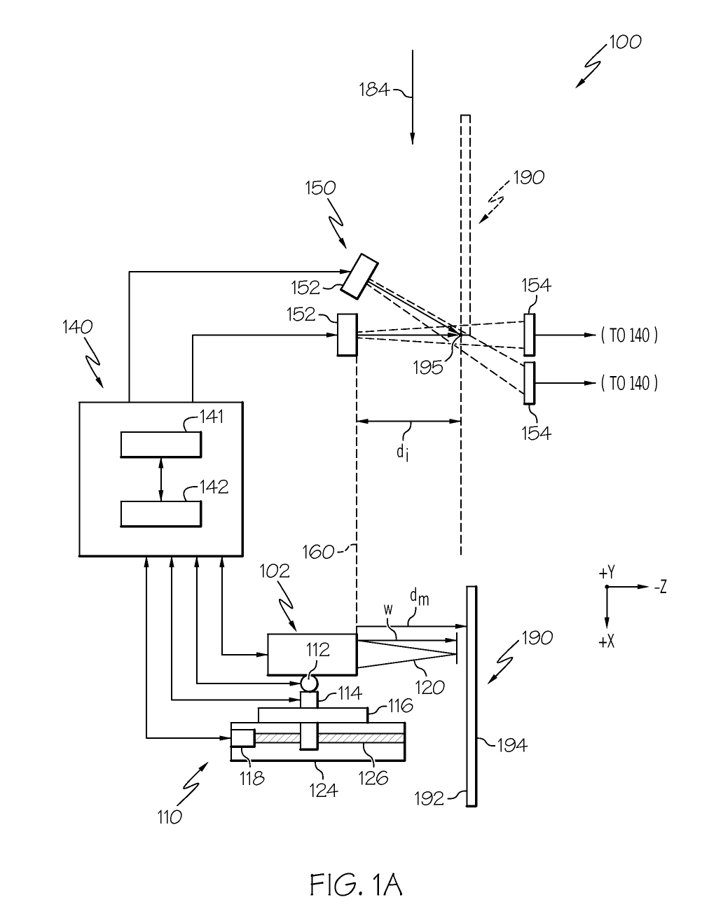

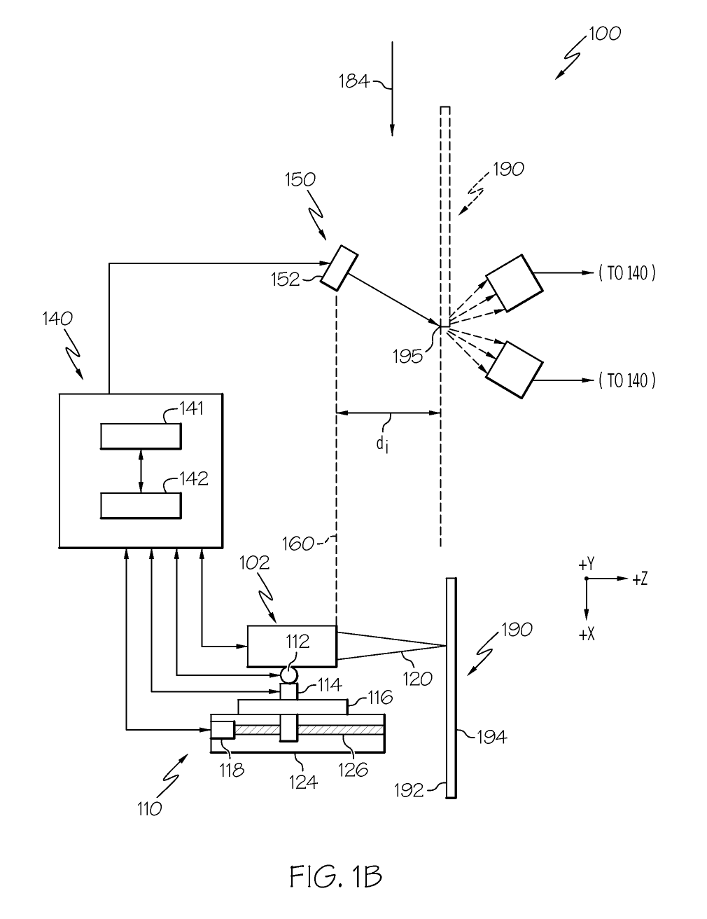

Reference will now be made in detail to various embodiments of online thickness measurement gauges for measuring the thickness of glass substrates, examples of which are illustrated in the accompanying drawing. Whenever possible, the same reference numerals will be used throughout the drawings to refer to the same or like parts. One embodiment of an online thickness measurement gauge is schematically depicted in FIG. 1A. The online thickness measurement gauge generally comprises an optical measurement head adjustably mounted on a positioning device such that the position of the optical measurement head can be adjusted with respect to a glass substrate. The online thickness measurement gauge may also include an edge detection system for detecting a leading edge of the glass substrate. In some embodiments, the positioning device of the online thickness measurement gauge may also include a tilt adjustment mechanism and/or a tip adjustment mechanism for adjusting a tilt orientation and/or a tip orientation of the optical measurement head, respectively. The online thickness measurement gauge and methods of using the online thickness measurement gauge will be described in more detail herein.

The term “initial separation distance,” as used herein, refers to the spacing between a leading edge of the glass substrate and the imaging plane of the optical measurement head of the online thickness measurement gauge. Similarly, the term “measurement separation distance,” as used here, refers to the spacing between a first surface plane of the glass substrate and the imaging plane of the optical measurement head of the online thickness measurement gauge.

The term “working distance,” as used herein, refers to a relative position between the optical measurement head of the online thickness measurement gauge and a first surface of the glass substrate where the focal point of the convergent output beam of the optical measurement head is positioned on the first surface plane of the glass substrate. The term “working range,” as used herein, refers to a range of separation distances between the glass substrate and the optical measurement head within which the optical measurement head is operable to accurately determine a thickness of the glass substrate. The working distance is thus within the working range.

Referring to FIG. 1A, an online thickness measurement gauge 100 for measuring a thickness of a glass substrate 190 is schematically depicted. The online thickness measurement gauge 100 generally comprises an optical measurement head 102 coupled to a positioning device 110. A control unit 140 is communicatively coupled to the optical measurement head 102 and the positioning device 110. The optical measurement head 102 of the online thickness measurement gauge may be one of several types of optical measurement instruments suitable for measuring a thickness of a glass substrate as well as the separation distance between the glass substrate and the optical measurement head, including, without limitation, low coherence interferometry devices, confocal devices and optical triangulation devices. For example, in one embodiment, the optical measurement head 102 is a low coherence interferometer such as the OptiGauge™ instrument manufactured by Lumetrics. In another embodiment, the optical measurement head 102 may be a confocal device such as the LT series of confocal devices manufactured by Keyence Corporation or a confocal chromatic sensor manufactured by Micro-Epsilon. However, it should be understood that other types of optical measurement instruments can be utilized as the optical measurement head 102 of the online thickness measurement gauge 100.

The positioning device 110 generally comprises a rail 124 and a stage 116 that is positionable along the length of the rail 124. The optical measurement head 102 is positioned on the stage 116. In the embodiment shown in FIG. 1A, the rail includes a worm gear 126 that extends along a length of the rail 124. The worm gear 126 is driven by a motor 118. The stage 116 is mechanically coupled to the worm gear 126 such that, as the worm gear 126 is rotated by motor 118, the stage 116 and optical measurement head 102 traverse along the rail 124 in the +/−Z direction of the coordinate axes depicted in FIG. 1A. The direction of traverse is dependent on the rotational direction of the motor 118. The positioning device 110 may be used to position the optical measurement head 102 with respect to the glass substrate 190.

In the embodiment of the online thickness measurement gauge 100 schematically illustrated in FIG. 1A, the positioning device 110 further comprises a tilt adjustment mechanism 112 and a tip adjustment mechanism 114. The tilt adjustment mechanism 112 is positioned on the stage 116 and coupled to the optical measurement head 102. In one embodiment, the tilt adjustment mechanism 112 is a motor, such as a stepper motor, which is operable to adjust the angular orientation (i.e., the tilt orientation) of the optical measurement head 102 about an axis of rotation parallel to the X-axis of the coordinate system shown in FIG. 1A. As the tilt orientation of the optical measurement head 102 is adjusted about an axis of rotation parallel to the X-axis, the angular orientation of the imaging plane 160 of the optical measurement head 102 is adjusted with respect to the glass substrate 190. In some embodiments, the online thickness measurement gauge 100 may be further capable of estimating the tilt angle of the glass substrate 190, as will be described in more detail herein. The estimated tilt angle may be used to control the tilt orientation of the optical measurement head 102 and thereby improve the accuracy of thickness measurements performed by the online thickness measurement gauge 100.

Similarly, the tip adjustment mechanism 114 may also be positioned on the stage 116 and coupled to the optical measurement head 102. In one embodiment, the tip adjustment mechanism 114 is a motor, such as a stepper motor, which is operable to adjust the angular orientation (i.e., the tip orientation) of the optical measurement head 102 about an axis of rotation parallel to the Y-axis of the coordinate system shown in FIG. 1A. As the tip orientation of the optical measurement head 102 is adjusted about an axis of rotation parallel to the Y-axis, the angular orientation of the imaging plane 160 of the optical measurement head 102 is adjusted with respect to the glass substrate 190.

While the tilt adjustment mechanism 112 and the tip adjustment mechanism 114 have been described herein as motors, other types of actuators may also be used. For example, in alternative embodiments, the tilt adjustment mechanism 112 and tip adjustment mechanism 114 may be constructed from other types of actuators including, without limitation, hydraulic actuators, pneumatic actuators, piezo-electric actuators or the like.

Moreover, while the positioning device 110 has been described herein as comprising a tilt adjustment mechanism 112 and a tip adjustment mechanism 114, the tilt adjustment mechanism 112 and the tip adjustment mechanism 114 are optional. For example, in one embodiment (not shown), the positioning device 110 may be constructed without a tilt adjustment mechanism or a tip adjustment mechanism. In another embodiment, the positioning device 110 may be constructed with only a tilt adjustment mechanism, such as when the positioning device includes a rail, a stage slidably positioned on the rail, and a tilt adjustment mechanism coupled to the stage. Alternatively, the positioning device 110 may be constructed with only a tip adjustment mechanism, such as when the positioning device includes a rail, a stage slidably positioned on the rail, and a tip adjustment mechanism coupled to the stage. In one embodiment, the optics of the online thickness measurement gauge 100 have sufficient tip and tilt tolerance to compensate for variations in the orientation of the glass substrate 190. As the tip and tilt tolerances of the measurement head increase, the working distance W and the working range of the of the optical measurement head 102 decrease. However, in one embodiment, the positioning device 110 is operable to adjust the position of the optical measurement head 102 with respect to the glass substrate 190 as the tip and tilt angle change thereby maintaining the accuracy of the accuracy of the online thickness measurement gauge 100.

The control unit 140 is communicatively coupled to the positioning device 110 and the optical measurement head 102. The control unit 140 generally comprises a processor 141 and a memory 142 communicatively coupled to the processor 141. The memory 142 stores a computer readable and executable instruction set for controlling the positioning device 110 and optical measurement head 102. More specifically, the processor 141 may execute the computer readable and executable instruction set stored in the memory 142 to send control signals to both the optical measurement head 102 and the positioning device 110, receive position feedback signals from the positioning device 110, and receive data signals from the optical measurement head 102 indicative of a measured thickness Tₘ of the glass substrate 190 and the separation distance between the optical measurement head 102 and a first surface plane of the glass substrate 190. The control signals sent to the optical measurement head 102 are utilized to switch the output beam 120 of the optical measurement head 102 on and off. The control signals sent to the positioning device 110 from the processor may be utilized to adjust the position of the optical measurement head 102 on the rail 124, adjust the tilt orientation of the optical measurement head 102, and/or adjust the tip orientation of the optical measurement head 102. The position feed back signals received from the positioning device 110 may be utilized to determine the position of the stage 116 relative to the rail 124 and/or the angular orientation of the tilt adjustment mechanism 112 or the tip adjustment mechanism 114. In some embodiments, the processor 141 also determines an adjusted thickness Tₐ of the glass substrate 190 based on the angular orientation of the glass substrate and the measured thickness Tₘ of the glass substrate 190, as will be described in more detail herein.

Still referring to FIG. 1A, in one embodiment, the online thickness measurement gauge 100 further includes an edge detector 150 which is communicatively coupled to the control unit 140. In the embodiment depicted in FIG. 1A, the edge detector 150 utilizes a projection method to determine the initial separation distance dᵢ of a leading edge 195 of the first surface plane 192 of the glass substrate 190 and the imaging plane 160 of the optical measurement head 102. For example, in the embodiment shown in FIG. 1A, the edge detector 150 utilizes a pair of light sources 152, such as broadband light sources or coherent light sources, to project light into the path of the glass substrate 190. The light sources 152 are communicatively coupled to the control unit 140. A pair of detectors 154, such as photo diodes or CCD arrays, are communicatively coupled to the control unit 140 and positioned opposite the light sources 152. The detectors 154 detect the light projected by the light sources 152. As the leading edge 195 of the first surface plane 192 passes through the projected light beams, the light is at least partially scattered and/or reflected. The detectors 154 register the position of the change in the intensity of the light beams and, based on the change in position registered by both detectors and the geometrical orientation of the light sources and the detectors, the control unit 140 determines the initial separation distance dᵢ between the leading edge 195 of the first surface plane 192 of the glass substrate 190 and the imaging plane 160 of the optical measurement head 102. In one embodiment, the initial position detection is performed at a position close to the thickness measurement location and at a predetermined distance from the optical measurement head 102. The separation distance between the edge detection system and the measurement head is sufficient such that the measurement head may be repositioned such that the glass substrate 190 is within the working range of the optical measurement head 102 as the glass substrate 190 is conveyed past the optical measurement head 102. The edge position measurements may be performed multiple times to increase the accuracy of the position measurement as the measurement of the thickness of the glass substrate 190 is performed by the optical measurement head 102.

Referring now to FIG. 1B, an alternative embodiment of an online thickness measurement gauge is schematically depicted. In this embodiment the edge detector 150 comprises a stereoscopic vision system which includes a single light source 152, such as a broadband light source or a coherent light source, and a pair of optical detectors 154, such as CCD arrays, photo diodes, or the like. The light source 152 and optical detectors 154 are coupled to the control unit 140 which switches the light source 152 on and off and receives output signals from the optical detectors 154 indicative of the intensity of the light received by each of the detectors 154. As the leading edge 195 of the first surface plane 192 of the glass substrate passes through the light beam emitted by the light source 152, the optical detectors 154 register the light scattered from the leading edge 195 of the glass substrate 190 and output signals to the control unit 140 indicative of the intensity of the scattered light. The control unit determines the initial separation distance dᵢ between the leading edge 195 of the first surface plane 192 of the glass substrate 190 and the imaging plane 160 of the optical measurement head 102 based on the measured intensity of the scattered light.

While FIGS. 1A and 1B depict edge detectors which utilize projection methods (FIG. 1A) or stereoscopic techniques (FIG. 1B) to determine the initial separation distance dᵢ between the leading edge 195 of the first surface plane 192 of the glass substrate 190 and the imaging plane 160 of the optical measurement head 102, the edge detector 150 of the online thickness measurement gauge may utilize other techniques and/or systems for detecting the initial separation distance dᵢ between the leading edge 195 of the first surface plane 192 of the glass substrate 190 and the imaging plane 160 of the optical measurement head 102.

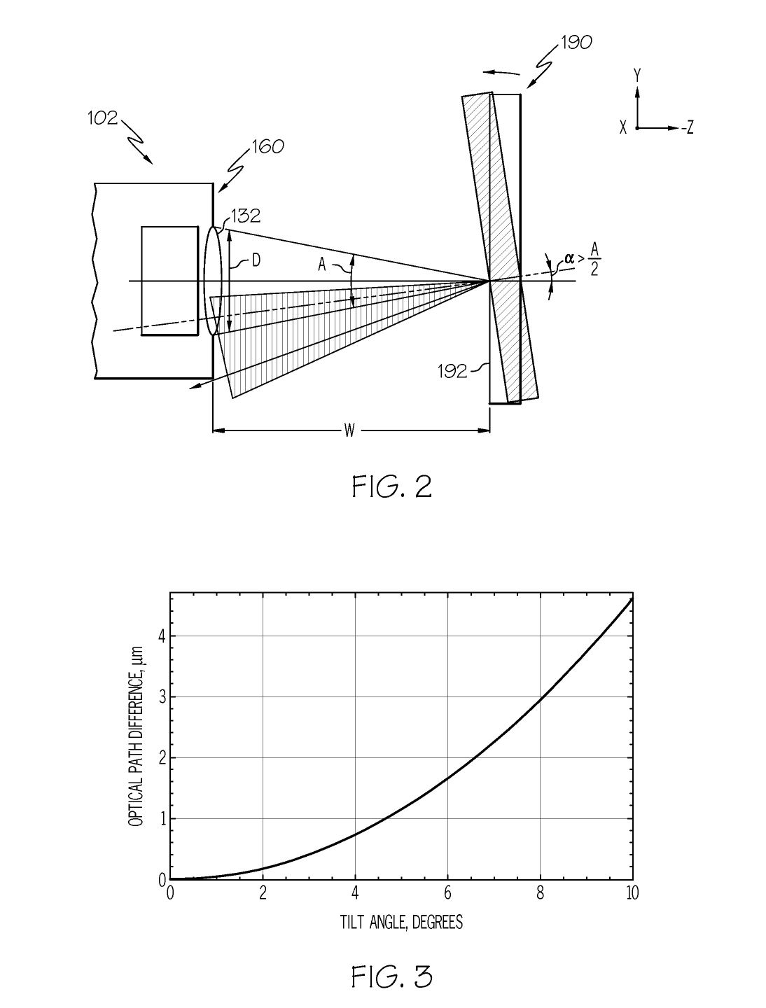

Referring now to FIG. 2, the optical measurement head 102 of the online thickness measurement gauge 100 is sensitive to the separation distance between the glass substrate 190 and the optical measurement head 102 as well as the angular orientation of the glass substrate 190. Specifically, the working distance W of the optical measurement head 102 is the point where the output beam 120 converges to a single point. The relationship between the working distance W, the diameter D of the imaging aperture of the optical measurement head and the angular aperture A of the output beam 120 and may be mathematically expressed as

$$W = \frac{D}{2 Tan ( A / 2 )} .$$

If the glass substrate 190 is positioned at the working distance W (or within a working range of the optical measurement head) and the first surface plane 192 of the glass substrate 190 is parallel with the imaging plane 160 of the optical measurement head 102, all the light reflected from the glass substrate will pass back through the imaging aperture 132 and be received by the imaging optics of the optical measurement head 102. However, if the first surface plane 192 of the glass substrate 190 is positioned outside the working range of the optical measurement head (i.e., the separation distance between the first surface plane 192 and the imaging plane 160 of the optical measurement head 102 is outside the working range of the optical measurement head), the light reflected back through the imaging aperture 132 is decreased which, in turn, introduces error in the thickness measurement. The angular aperture of the measurement head may be increased by using a shorter focal length lens in the imaging optics of the optical measurement head which, in turn, increases the amount of light which may be received into the measurement head at high angles of divergence. However, the increase in the angular aperture causes a corresponding decrease in the working distance W.

Further, if the glass substrate 190 is oriented at a tilt angle α (i.e., the glass substrate 190 is rotated about an axis of rotation parallel to the X-axis of the coordinate axes depicted in FIG. 2), the amount of light reflected back through the imaging aperture will also be reduced which, in turn, introduces an error in the thickness measurement. As graphically depicted in FIG. 3, as the tilt angle of the glass substrate increases, the optical path though the glass substrate also increases which, in turn, increases the error in the thickness measurement. In cases where the tilt angle α is greater than A/2, no light will be received by the optical measurement head 102 making it impossible to obtain a thickness measurement of the glass substrate 190.

While reference has been made hereinabove to the effect of the tilt angle α of the glass substrate 190 on measuring the thickness of the glass substrate, it should be understood that tipping the glass substrate by a tip angle β has a similar effect. For example, if the glass substrate 190 is rotated by a tip angle β about an axis of rotation parallel to the Y-axis of the coordinate axes depicted in FIG. 2, the amount of light reflected back through the imaging aperture will be reduced. In cases where the tip angle β is greater than A/2, no light will be received by the optical measurement head 102 making it impossible to obtain a thickness measurement of the glass substrate 190.

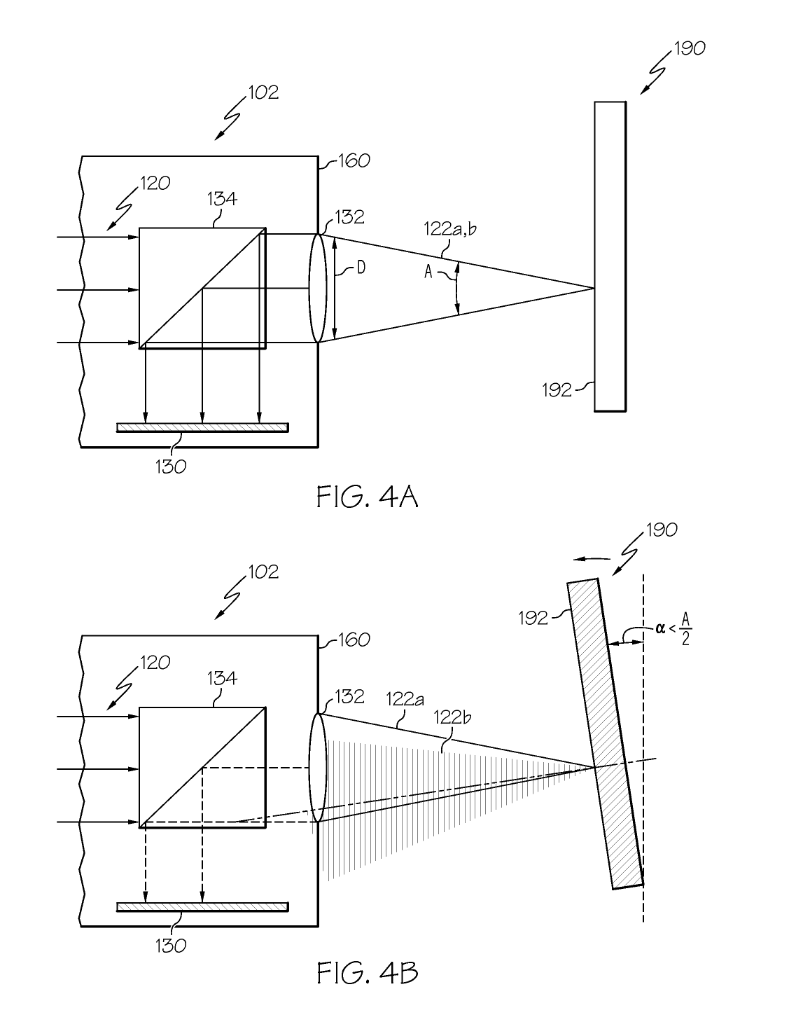

In some embodiments described herein, the online thickness measurement gauge 100 includes an angle detector which may be utilized to determine the tilt angle and/or tip angle of the glass substrate. In some embodiments, such information may be used to compensate for the tilt angle and/or tip angle of the glass substrate 190 during the thickness measurement process. Referring to FIG. 4A, in one embodiment, the optical measurement head 102 further comprises a beam splitter 134 positioned between the light source (not shown) and the imaging aperture 132. The beam splitter 134 is constructed such that the collimated output beam 120 of the optical measurement head 102 passes through the beam splitter 134 before being shaped into a converging output beam 122a by the imaging aperture 132 of the optical measurement head 102. The converging output beam is directed onto the first surface plane 192 of the glass substrate 190 and reflected back through the imaging aperture 132 as return beam 122b (i.e., the converging output beam 122a and the return beam 122b travel along the same optical path). The return beam 122b is incident on the beam splitter 134 which redirects a portion of the return beam 122b onto the angle detector 130. In the embodiments described herein, the angle detector 130 is an optical sensor, such as a CCD array or similar optical sensor, operable to detect the intensity of a light beam and a plurality of positions of the return beam 122b on the detector in one or two dimensional space. The angle detector, which is communicatively coupled to the control unit 140 (FIG. 1A), outputs a signal indicative of the intensity of the return beam 122b as well as the spatial location of the return beam 122b on the angle detector 130.

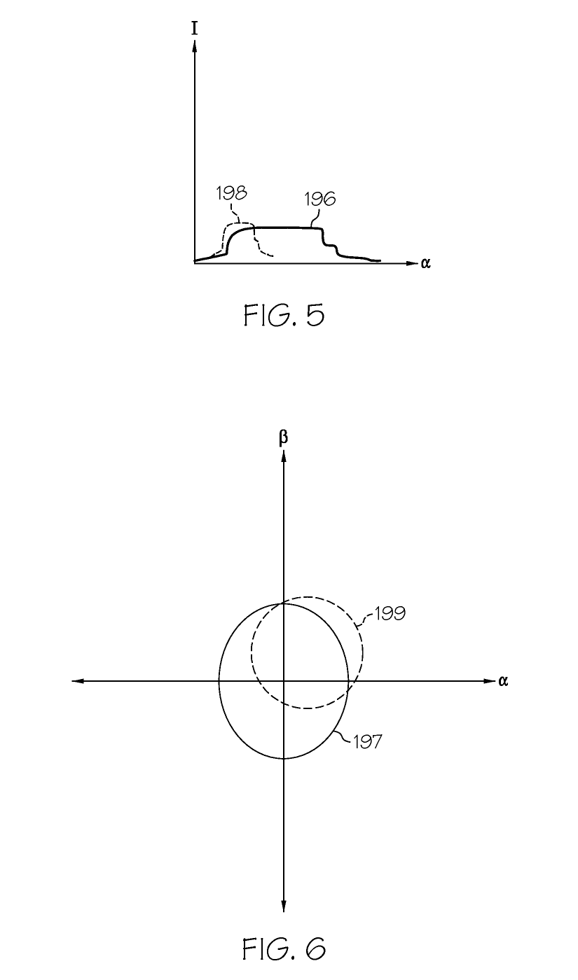

Referring now to FIGS. 4A, 5 and 6, when the first surface plane 192 of the glass substrate 190 is substantially parallel with the imaging plane 160 of the optical measurement head 102, as illustrated in FIG. 4A, the converging output beam 122a is reflected from the first surface plane 192 as return beam 122b. Return beam 122b passes through the imaging aperture 132 and onto the beam splitter 134 where a portion of the reflected light is diverted onto the angle detector 130. The angle detector 130 registers the intensity and spatial location of the return beam 122b and outputs an intensity distribution signal corresponding to both the intensity of the return beam 122b as well as to the spatial location of the return beam 122b on the angle detector 130. The output signal of the angle detector 130 may be processed by the control unit 140 (FIG. 1A) to determine the tilt angle α and the tip angle β of the glass substrate. An exemplary light intensity distribution 196 of a return beam 122b reflected from the glass substrate 190 of FIG. 4A is graphically depicted in FIG. 5. A corresponding light intensity distribution 197 is graphically depicted in FIG. 6 as a function of both the tip angle α and the tilt angle β.

Referring to FIGS. 4B, 5 and 6, when the first surface plane 192 of the glass substrate 190 is non-parallel with the imaging plane 160 of the optical measurement head 102, as illustrated in FIG. 4B where the glass substrate has a tilt angle α, the converging output beam 122a is reflected from the first surface plane 192 as return beam 122b. However, because the glass substrate 190 has as tilt angle α, only a fraction (i.e., less than 100 percent) of the return beam 122b passes through the imaging aperture 132 and onto the beam splitter 134. The fraction of light incident on the beam splitter 134 is diverted onto the angle detector 130. The angle detector 130 registers the intensity and spatial location of the return beam 122b and outputs a signal corresponding to both the intensity of the return beam 122b and the spatial location of the return beam 122b on the angle detector 130. The output signal of the angle detector 130 is processed by the control unit 140 (FIG. 1A) to determine the tilt angle α and the tip angle β of the glass substrate. An exemplary light intensity distribution 198 of a return beam 122b reflected from the glass substrate 190 of FIG. 4B is depicted in FIG. 5. A corresponding light intensity distribution 199 is depicted in FIG. 6 as a function of both the tip angle α and the tilt angle β. As shown in FIGS. 5 and 6, the diameter of the beam spot incident on the angle detector 130 decreases as the tilt angle α and/or the tip angle β increase. Furthermore, as the tilt angle α and/or the tip angle β are increased or decreased, the spatial location of the beam spot on the angle detector 130 is shifted. Accordingly, the angle detector 130 and control unit may be calibrated to determine both the tilt angle α and the tip angle β based on the location of the return beam 122b on the angle detector 130.

In one embodiment, the control unit 140 may utilize the light intensity distribution, tilt angle α, and/or the tip angle β to determine an adjusted thickness Tₐ of the glass substrate 190 based on the measured thickness Tₘ of the glass substrate 190. For example, where the glass substrate has a tilt angle α, the adjusted thickness Tₐ may be expressed as:

Tₐ=K_{α}Tₘ, where:

Tₘ is the thickness of the glass substrate measured with the optical measurement head;

K_{α} is the correction function expressed as

$${K}_{α} = \sqrt{1 - \frac{{Sin}^{2} α}{{n}_{glass}^{2}}} ;$$

and

n_{glass} is a refractive index of the glass substrate.

Similarly, where the glass substrate has a tip angle β, the adjusted thickness Tₐ may be expressed as:

Tₐ=K_{β}Tₘ, where:

Tₘ is the thickness of the glass substrate measured with the optical measurement head;

K_{β} is the correction function expressed as

$${K}_{β} = \sqrt{1 - \frac{{Sin}^{2} β}{{n}_{glass}^{2}}} ;$$

and

n_{glass} is the refractive index of the glass substrate.

Similarly, where the glass substrate has both a tilt angle α and a tip angle β, the adjusted thickness Tₐ may be expressed as:

Tₐ=K_{αβ}Tₘ, where:

Tₘ is the thickness of the glass substrate measured with the optical measurement head;

K_{αβ} is the correction function expressed as

$${K}_{αβ} = \sqrt{1 - \frac{{Sin}^{2} α + {Sin}^{2} β}{{n}_{glass}^{2}}} ;$$

and

n_{glass} is the refractive index of the glass substrate.

In one embodiment, the correction functions K_{β} and K_{α} (or the combined correction function K_{αβ}) may be stored in the memory 142 of the control unit 140 in a look-up table (LUT) indexed according to light intensity distributions signals from the angle detector 130 corresponding to various values of the tilt angle α and/or the tip angle β. When the control unit 140, specifically the processor 141 of the control unit 140, receives an intensity distribution signal from the angle detector 130, the processor determines the corresponding correction functions K_{β}, K_{α} and/or K_{αβ} and calculates a value for the adjusted thickness Tₐ of the glass substrate based on the measured thickness Tₘ and the correction function(s).

In another embodiment, the adjusted thickness Tₐ of the glass substrate may be adjusted by collecting a light intensity distribution of a return beam reflected by the glass substrate. The light intensity distribution is stored in the memory of the control unit 140. The processor then compares the collected light intensity distribution to a nominal light intensity distribution for a baseline glass substrate (i.e., a glass substrate which is oriented in parallel to the imaging plane 160 of the optical measurement head), which is also stored in a memory of the control unit 140, to determine the tilt angle α and/or the tip angle β. The adjusted thickness Tₐ of the glass substrate is then determined by the processor utilizing the measured thickness Tₘ and the correction functions K_{β}, K_{α}, and/or K_{αβ}.

Referring now to FIGS. 1A and 7-8, in another embodiment, the tilt angle α and/or the tip angle β may be utilized to improve the accuracy of the thickness measurement made with the optical measurement head 102 by compensating for the tilt angle α and/or the tip angle β and/or to widen the range of tilt and/or tip angles where the measurement of the thickness of the glass substrate is made possible. In this embodiment, the tilt angle α and/or the tip angle β may be determined with the control unit 140 based on a light intensity distribution signal received from the angle detector 130. Thereafter, the control unit 140 utilizes the value of the tilt angle α and/or the tip angle β to adjust an angular orientation of the optical measurement head 102 with the tilt adjustment mechanism 112 and/or the tip adjustment mechanism 114 such that the imaging plane 160 of the optical measurement head 102 is substantially parallel with the first surface plane of the glass substrate 190.

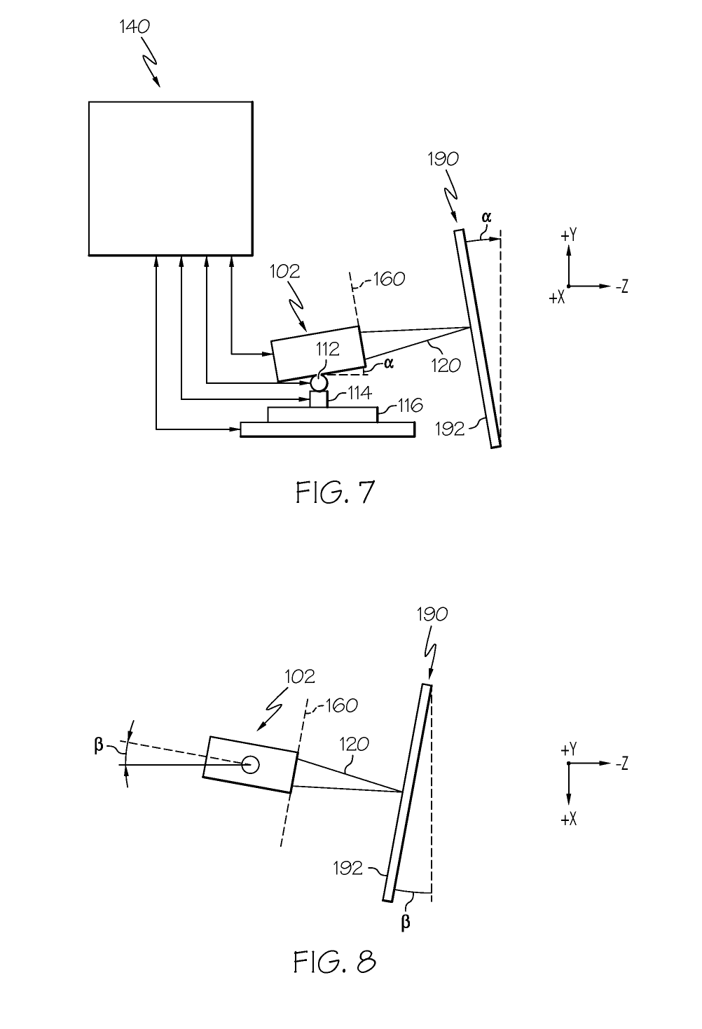

For example, FIG. 7 schematically depicts adjusting the angular orientation of the optical measurement head 102 to compensate for the tip angle α of the glass substrate 190. In this example, the glass substrate 190 is rotated about an axis of rotation parallel to the X-axis of the coordinate axes of FIG. 7 in a counterclockwise direction by a tilt angle α. To compensate for this tilt angle, the control unit 140 adjusts the angular orientation of the optical measurement head 102 with the tilt adjustment mechanism 112 such that the imaging plane of the optical measurement head 102 is parallel with the first surface plane 192 of the glass substrate 190. Specifically, the control unit 140 rotates the optical measurement head 102 with the tilt adjustment mechanism 112 in a counterclockwise direction about an axis of rotation parallel to the X-axis of the coordinate axes of FIG. 7 by the tilt angle α.

Similarly, FIG. 8 schematically depicts adjusting the angular orientation of the optical measurement head 102 to compensate for the tip angle β of the glass substrate 190. In this example, the glass substrate 190 is rotated about an axis of rotation parallel to the Y-axis of the coordinate axes of FIG. 8 in a counterclockwise direction by a tip angle β. To compensate for this tip angle, the control unit 140 adjusts the angular orientation of the optical measurement head 102 with the tip adjustment mechanism 114 such that the imaging plane of the optical measurement head 102 is parallel with the first surface plane 192 of the glass substrate 190. Specifically, the control unit 140 rotates the optical measurement head 102 with the tip adjustment mechanism 114 in a counterclockwise direction about an axis of rotation parallel to the Y-axis of the coordinate axes of FIG. 8 by the tip angle β.

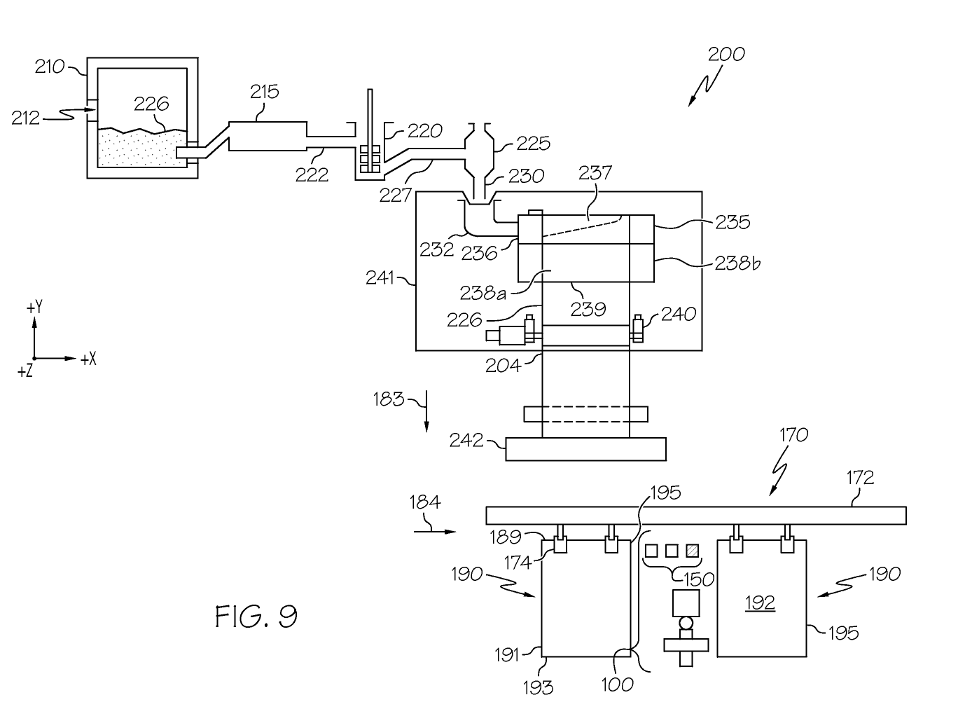

Referring now to FIG. 9, one embodiment of an exemplary glass manufacturing system 200 is schematically depicted which utilizes the online thickness measurement gauge described herein. The glass manufacturing system 200 includes a melting vessel 210, a fining vessel 215, a mixing vessel 220, a delivery vessel 225, a fusion draw machine (FDM) 241 and a traveling anvil machine (TAM) 242. Glass batch materials are introduced into the melting vessel 210 as indicated by arrow 212. The batch materials are melted to form molten glass 226. The fining vessel 215 has a high temperature processing area that receives the molten glass 226 from the melting vessel 210 and in which bubbles are removed from the molten glass 226. The fining vessel 215 is fluidly coupled to the mixing vessel 220 by a connecting tube 222. The mixing vessel 220 is, in turn, fluidly coupled to the delivery vessel 225 by a connecting tube 227.

The delivery vessel 225 supplies the molten glass 226 through a downcomer 230 into the FDM 241. The FDM 241 comprises an inlet 232, a forming vessel 235, and a pull roll assembly 240. As shown in FIG. 9, the molten glass 226 from the downcomer 230 flows into an inlet 232 which leads to the forming vessel 235. The forming vessel 235 includes an opening 236 that receives the molten glass 226 which flows into a trough 237 and then overflows and runs down two sides 238a and 238b before fusing together at a root 239. The root 239 is where the two sides 238a and 238b come together and where the two overflow walls of molten glass 226 rejoin (e.g., refuse) before being drawn downward by the pull roll assembly 240 to form the continuous glass ribbon 204.

As the continuous glass ribbon 204 exits the pull roll assembly 240, the molten glass solidifies. The continuous glass ribbon 204 is drawn in a downward draw direction 183 through TAM 242 where the continuous glass ribbon 204 is segmented into individual glass substrates 190. Each glass substrate 190 has a pair of opposed surface planes (i.e., a first surface plane 192 and a second surface plane 194, as depicted in FIG. 1A) which are bounded by edges 189, 191, 193, and 195. The surface planes of the glass substrate are generally parallel with the downward draw direction 183 as the glass substrate 190 is drawn in the downward draw direction 183. As the glass substrates 190 are segmented from the continuous glass ribbon 204, hangers 174 are attached to the glass substrates 190. The hangers 174 are utilized to suspend the glass substrate from a conveyor rail 172 of a conveyor 170 which transports the glass substrates 190 in a conveyance direction 184 to additional processing and/or packaging.

Methods of using the online thickness measurement gauge 100 in conjunction with the glass manufacturing system 200 depicted in FIG. 9 will now be described with specific reference to FIGS. 1A and 9.

After the continuous glass ribbon 204 has been segmented by the TAM into individual glass substrates 190, the glass substrate are conveyed in the conveyance direction 184. In embodiments where the online thickness measurement gauge 100 comprises an edge detector 150, the edge detector 150 is utilized to determine an initial separation distance dᵢ between a leading edge 195 of the first surface plane of the glass substrate and the optical measurement head 102 as the glass substrate is conveyed in the conveyance direction 184. Utilizing the separation distance dᵢ, the control unit 140 adjusts the position of the optical measurement head relative to the first surface plane of the glass substrate such that the first surface plane is within the working range of the optical measurement head 102. In the embodiment shown in FIG. 1A, the control unit 140 adjusts the position of the optical measurement head 102 in the −Z direction by sending a control signal to the motor 118 which, in turn, rotates the worm gear 126 until the optical measurement head 102/stage 116 are positioned such that the first surface plane 192 of the glass substrate 190 is within the working range of the optical measurement head 102.

Thereafter, the measurement separation distance dₘ between the first surface plane 192 of the glass substrate 190 and the imaging plane 160 of the optical measurement head 102 is determined with the optical measurement head 102 as the glass substrate is conveyed past the measurement head in the conveyance direction 184. The control unit 140 utilizes the measurement separation distance dₘ to insure that the first surface plane 192 of the glass substrate is within the working range of the optical measurement head 102. In one embodiment, when the working distance of the optical measurement head 102 is less than the measurement separation distance dₘ and the measurement separation distance is dₘ is outside the working range of the optical measurement head 102, the control unit 140 adjusts the position of the optical measurement head 102 until the measurement separation distance dₘ is within the working range of the optical measurement head 102. In another embodiment, when the working distance W of the optical measurement head 102 is greater than the measurement separation distance dₘ and the measurement separation distance is dₘ is outside the working range of the optical measurement head 102, the control unit 140 adjusts the position of the optical measurement head 102 until the measurement separation distance dₘ is within the working range of the optical measurement head 102. Maintaining the measurement separation distance dₘ within the working range of the optical measurement head 102 improves the accuracy of the resulting thickness measurement.

While the initial separation distance dᵢ has been described herein as being determined as the glass substrate 190 is conveyed in the conveyance direction 184, in other embodiments, the initial separation distance dᵢ may be determined as the glass substrate 190 is conveyed in the downward draw direction 183.

Once the measurement separation distance dₘ is within the working range of the optical measurement head 102, the control unit 140 measures the thickness Tₘ of the glass substrate with the optical measurement head 102. The measured thickness Tₘ is stored in the memory of the control unit 140. In one embodiment (not shown), the measured thickness Tₘ is used as a real-time feedback control for adjusting process variables of the glass manufacturing system 200 to achieve the desired glass thickness and thickness uniformity across the draw. In another embodiment, the stored measured thickness Tₘ may be subsequently accessed for further processing and quality control of the glass substrates produced with the glass manufacturing system 200 (i.e., segregation of non-conforming products and the like).

In embodiments where the optical measurement head 102 comprises an angle sensor, as described herein, the tilt angle α and/or tip angle β may be determined by the control unit 140 as the glass substrate 190 is conveyed in the conveyance direction. In one embodiment, the tilt angle α and/or tip angle β may be used to determine an adjusted thickness Tₐ of the glass substrate 190, as described hereinabove.

In embodiments where the positioning device 110 comprises a tilt adjustment mechanism 112 and/or a tip adjustment mechanism 114, the tilt angle α and/or tip angle β may be utilized by the control unit 140 to adjust the angular orientation of the optical measurement head 102 such that the imaging plane 160 of the optical measurement head 102 is parallel with the first surface plane 192 of the glass substrate 190. The adjustment of the angular orientation of the optical measurement head 102 is performed prior to measuring the thickness Tₘ of the glass substrate 190 which, in turn, improves the accuracy of the subsequent thickness measurement.

It should now be understood that the methods and apparatuses described herein may be used to improve the accuracy and consistency of thickness measurements performed on glass substrates. In one embodiment, the methods and apparatuses described herein may be utilized to improve the accuracy of thickness measurements by positioning the optical measurement head such that the glass substrates are within the working range of the optical measurement head. Monitoring and adjusting the separation distance between the glass substrate and the optical measurement head at frequencies which are faster than the frequency at which the thickness measurements are performed improves the overall accuracy and consistency of the thicknesses measurements.

In another embodiment, the methods and apparatuses described herein may be utilized to compensate for motion (i.e., tilt and/or tip) in the glass substrates as the glass substrates are conveyed through various manufacturing processes. The ability to compensate for the tip and/or tilt of the glass eliminates the need to constrain the glass with mechanical holders during measurement and, as such, reduces the potential for breaking or otherwise damaging the glass substrates during the measurement operation.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for determining a thickness of a glass substrate having a pair of opposed surface planes bounded by edges, the method comprising:
conveying the glass substrate past an optical measurement head;
determining a measurement separation distance dₘ between a first surface plane of the glass substrate and the optical measurement head as the glass substrate is conveyed past the optical measurement head;
adjusting a position of the optical measurement head relative to the first surface plane of the glass substrate based on the measurement separation distance dₘ between the first surface plane of the glass substrate and the optical measurement head such that the substrate is within a working range of the optical measurement head as the glass substrate is conveyed past the optical measurement head; and
measuring a thickness Tₘ of the glass substrate with the optical measurement head as the glass substrate is conveyed past the optical measurement head.

2. The method of claim 1, further comprising:
determining a tilt angle α of the glass substrate as the glass substrate is conveyed in a conveyance direction; and
adjusting an angular orientation of the optical measurement head based on the tilt angle α of the glass substrate such that an imaging plane of the optical measurement head is substantially parallel to the first surface plane of the glass substrate.

3. The method of claim 1, further comprising determining an adjusted thickness Tₐ based on the thickness Tₘ of the glass substrate and a tilt angle α of the glass substrate as the glass substrate is conveyed in a conveyance direction.

4. The method of claim 3, wherein the adjusted thickness Tₐ of the glass substrate is determined by:
directing a convergent beam onto the first surface plane of the glass substrate;
collecting a light intensity distribution of a return beam reflected from the glass substrate;
comparing the light intensity distribution of the return beam to a nominal light intensity distribution for a baseline glass substrate orientation to determine the tilt angle α; and
determining the adjusted thickness Tₐ, wherein:
Tₐ=K_{α}T_{M};
Tₘ is the thickness of the glass substrate measured with the optical measurement head; and
K_{α} is a correction function based on the tilt angle α and a refractive index of the glass substrate.

5. The method of claim 1, further comprising:
determining a tip angle β of the glass substrate as the glass substrate is conveyed in a conveyance direction; and
adjusting an angular orientation of the optical measurement head based on the tip angle β of the glass substrate such that an imaging plane of the optical measurement head is substantially parallel to the first surface plane of the glass substrate.

6. The method of claim 1, further comprising determining an adjusted thickness Tₐ of the glass substrate based on the thickness Tₘ of the glass substrate and a tip angle β of the glass substrate as the glass substrate is conveyed in a conveyance direction.

7. The method of claim 6, wherein the adjusted thickness Tₐ of the glass substrate is determined by:
directing a convergent beam onto the first surface plane of the glass substrate;
collecting a light intensity distribution of a return beam reflected from the glass substrate;
comparing the light intensity distribution of the return beam to a nominal light intensity distribution for a baseline glass substrate orientation to determine the tip angle β; and
determining an adjusted glass thickness Tₐ, wherein:
Tₐ=K_{β}T_{M};
Tₘ is the thickness of the glass substrate measured with the optical measurement head;
K_{β} is a correction function based on the tip angle β and a refractive index of the glass substrate.

8. The method of claim 1, further comprising:
determining a tilt angle α of the glass substrate as the glass substrate is conveyed in a conveyance direction;
determining a tip angle β of the glass substrate as the glass substrate is conveyed in the conveyance direction;
determining an adjusted thickness Tₐ of the glass substrate based on the thickness Tₘ of the glass substrate, tilt angle α of the glass substrate, and the tip angle β of the glass substrate as the glass substrate is conveyed in the conveyance direction.

9. The method of claim 8, wherein the adjusted thickness Tₐ of the glass substrate is determined such that Tₐ=K_{αβ}T_{M}, wherein:
K_{αβ} is a correction function based on the tilt angle α, the tip angle β and an index of refraction of the glass substrate.

10. The method of claim 1, further comprising:
detecting an initial separation distance dᵢ between a leading edge of the first surface plane of the glass substrate and the optical measurement head; and
adjusting the position of the optical measurement head relative to the first surface plane based on the initial separation distance dᵢ between the leading edge of the first surface plane of the glass substrate and the optical measurement head such that the first surface plane of the glass substrate is within the working range of the optical measurement head before the glass substrate is conveyed past the optical measurement head.

11. The method of claim 10, wherein the initial separation distance dᵢ between the leading edge of the first surface plane of the glass substrate and the optical measurement head is determined with a stereoscopic vision system.

12. The method of claim 10, wherein the initial separation distance dᵢ between the leading edge of the first surface plane of the glass substrate and the optical measurement head is determined by measuring a position of a change of an intensity of light scattered from the leading edge of the first surface plane of the glass substrate.

13. An online thickness measurement gauge for measuring a thickness Tₘ of a glass substrate having a first surface plane opposed to a second surface plane and bounded by edges, the online thickness measurement gauge comprising:
an optical measurement head;
a positioning device coupled to the optical measurement head; and
a control unit communicatively coupled to the optical measurement head and the positioning device, wherein the control unit:
determines the thickness Tₘ of the glass substrate with the optical measurement head;
determines a measurement separation distance dₘ between the optical measurement head and the first surface plane of the glass substrate; and
adjusts a position of the optical measurement head relative to the first surface plane with the positioning device based on the measurement separation distance dₘ between the first surface plane and the optical measurement head such that the glass substrate is maintained within a working range of the optical measurement head as the glass substrate is conveyed past the optical measurement head.

14. The online thickness measurement gauge of claim 13, further comprising:
an edge detector that detects a leading edge of the first surface plane of the glass substrate, wherein the edge detector is communicatively coupled to the control unit; and
the control unit determines an initial separation distance dᵢ between the optical measurement head and the first surface plane of the glass substrate and initially adjusts the position of the optical measurement head with respect to the first surface plane of the glass substrate based on the initial separation distance dᵢ between the optical measurement head and the leading edge of the glass substrate such that the first surface plane is within the working range of the glass substrate.

15. The online thickness measurement gauge of claim 14, wherein the edge detector is a stereoscopic vision system.

16. The online thickness measurement gauge of claim 13, further comprising:
an angle detector communicatively coupled to the control unit;
a beam splitter that diverts at least a portion of a return beam onto the angle detector, wherein the angle detector outputs to the control unit a light intensity distribution signal indicative of at least one of a tilt angle α of the glass substrate or a tip angle β of the glass substrate.

17. The online thickness measurement gauge of claim 16, wherein the positioning device comprises at least one of a tilt adjustment mechanism that adjusts a tilt orientation of the optical measurement head based on the tilt angle α of the glass substrate and a tip adjustment mechanism that adjusts a tip orientation of the optical measurement head based on the tip angle β of the glass substrate.

18. The online thickness measurement gauge of claim 16, wherein the control unit determines an adjusted thickness Tₐ of the glass substrate based on at least one of the of the tilt angle α of the glass substrate or the tip angle β of the glass substrate.

19. The online thickness measurement gauge of claim 13, wherein the optical measurement head is an optical triangulation device, a low coherence interferometry device, or a confocal device.

20. The online thickness measurement gauge of claim 13, wherein the positioning device comprises a stage movably coupled to a rail, wherein the optical measurement head is coupled to the stage.
